(19) United States
(12) Patent Application Publication
(10) Pub. No.: US 2025/0269544 A1
(43) Pub. Date: Aug. 28, 2025

(54) ADSORBING MECHANISM AND ADSORBING DEVICE WITH THE SAME

(71) Applicant: Asphetek Solution (Chengdu) Ltd., Chengdu (CN)

(72) Inventor: HSIANG TSAI, Hsinchu (TW)

(21) Appl. No.: 19/023,952

(22) Filed: Jan. 16, 2025

(30) Foreign Application Priority Data
Feb. 28, 2024 (CN) 202420375830.1

(51) Int. Cl. B25J 15/06; B65G 47/91

(52) U.S. Cl. CPC B25J 15/0666; B65G 47/918

(57) ABSTRACT

The present disclosure provides an adsorbing mechanism and an adsorbing device with the same. The adsorbing mechanism includes: a base, a plurality of suction cup units disposed on the base, and a clamping unit. The suction cup unit is used to telescopically move along a first direction, and the suction cup unit is connected to an external vacuum device, such that negative pressure is generated in the suction cup units for adsorbing a product. The clamping unit disposed on a side of the base along the first direction. The clamping unit includes a first clamping member and a second clamping member. Wherein at least one of the first clamping member and the second clamping member is configured to move close to or away from each other to clamp or release the suction cup units.

### FIELD

The subject matter relates to adsorption of products, and more particularly, to an adsorbing mechanism and an adsorbing device with the adsorbing mechanism.

### BACKGROUND

In actual production and processing, products need to be transferred between different processing stations. During the transfer of the product, a clamping mechanism or an adsorbing mechanism is used to secure the product. The adsorbing mechanism, such as an electrostatic chuck, may be suitable to be used in a limited space.

However, when the product has an irregular surface, such as a convex or concave surface, the existing adsorbing mechanism may not be fully attached to the product, which may cause the product to fall and break during the adsorption and transferring process.

Therefore, there is room for improvement in the art.

### BRIEF DESCRIPTION OF THE DRAWINGS

Implementations of the present technology will now be described, by way of example only, with reference to the attached figures.

FIG. 1 is a diagrammatic view of an adsorbing device according to an embodiment of the present disclosure.

FIG. 2 is a diagrammatic view of an adsorbing mechanism of the adsorbing device in FIG. 1.

FIG. 3 is a diagrammatic view showing the adsorbing mechanism in FIG. 2, adsorbing a product.

FIG. 4 is a diagrammatic view showing the adsorbing mechanism in FIG. 3, lifting up the adsorbed product.

FIG. 5 is a diagrammatic view of a suction cup unit of the adsorbing mechanism in FIG. 2.

### DETAILED DESCRIPTION

It will be appreciated that for simplicity and clarity of illustration, where appropriate, reference numerals have been repeated among the different FIG.s to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

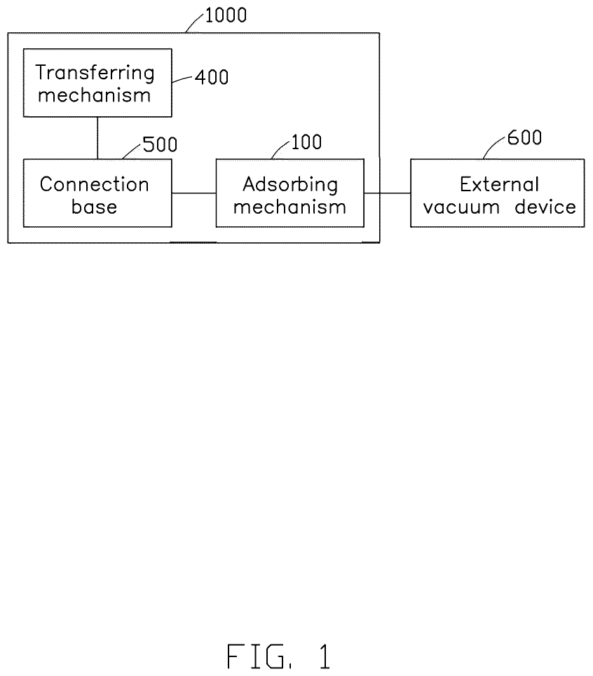

Referring to FIG. 1, an adsorbing device 1000 is provided according to an embodiment of the present disclosure. The adsorbing device 1000 is used to adsorb a product 200. The adsorbing device 1000 includes an adsorbing mechanism 100 and a transferring mechanism 400. The transferring mechanism 400 is used to drive the adsorbing mechanism 100 to move. The adsorbing device 1000 further includes an external vacuum device 600 connected to the adsorbing mechanism 100. It can be understood that the adsorbing device 1000 may not include the external vacuum device 600. That is, the external vacuum device 600 may be independent from the adsorbing device 1000.

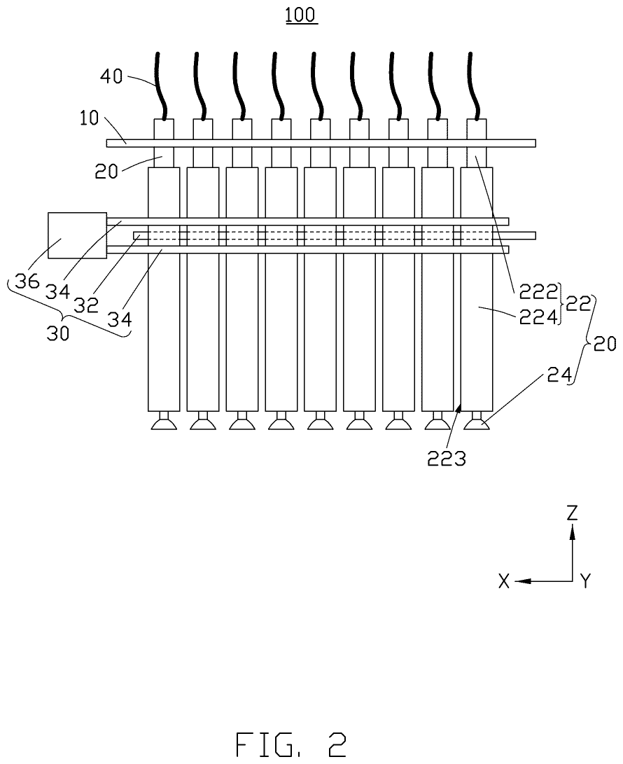

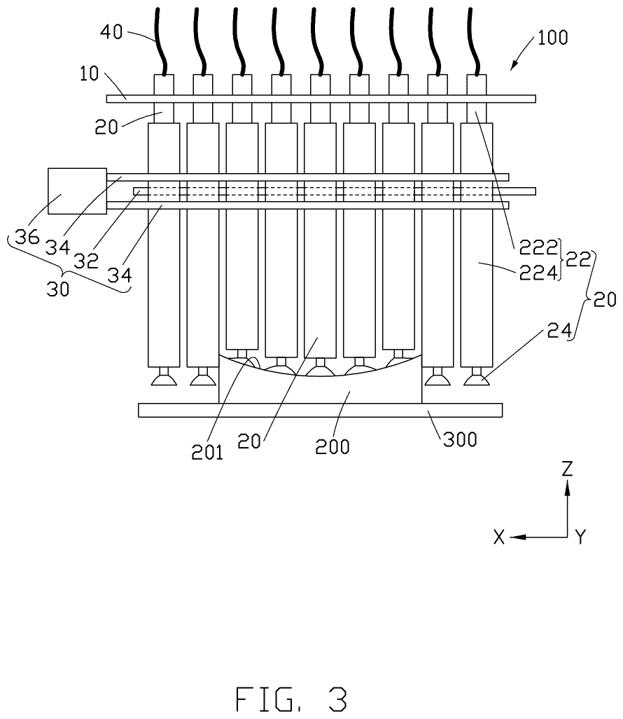

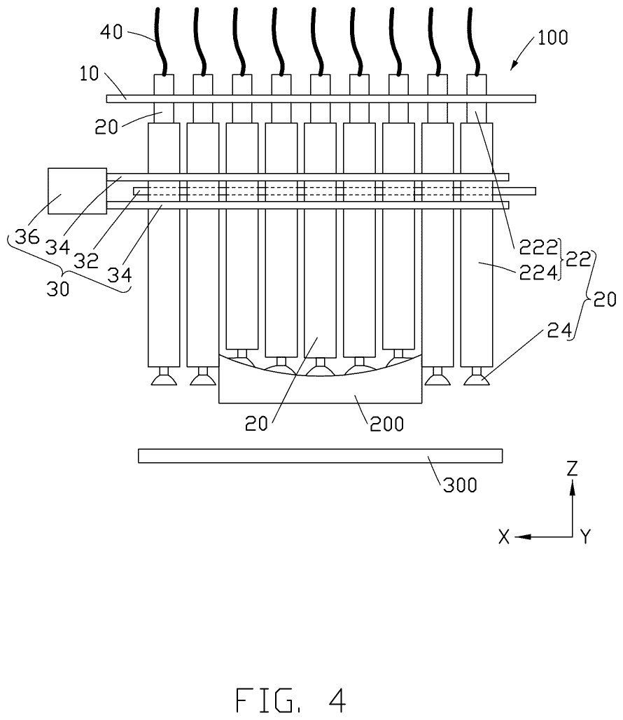

Referring to FIGS. 2 to 4, the adsorbing mechanism 100 is provided according to an embodiment of the present disclosure. The adsorbing mechanism 100 is used to adsorb the product 200. The product 200 has an adsorbing surface 201. In an embodiment, the adsorbing surface 201 of the product 200 can be a flat surface, a convex surface, a concave surface, and a stepped surface. The adsorbing mechanism 100 includes a base 10, a plurality of suction cup units 20, and a clamping unit 30. The suction cup units 20 are arranged on the base 10 and parallel to each other. The suction cup units 20 can be telescopically arranged on the base 10, that is, each suction cup unit 20 can telescopically move along a first direction Z relative to the base 10. The suction cup unit 20 is connected to the external vacuum device 600, which generates negative pressure in the suction cup unit 20 for adsorbing the adsorbing surface 201 of the product 200. The clamping unit 30 is disposed on a side of the base 10 along the first direction Z. The clamping unit 30 is configured to clamp all of the suction cup units 20.

In an embodiment, the base 10 may be a plate-shaped structure. The suction cup unit 20 extends through the base 10 and parallel to each other. The base 10 provides support for the suction cup units 20.

In an embodiment, the suction cup units 20 are arranged in a row along a second direction X on the base 10. The second direction X is perpendicular to the first direction Z. The suction cup units 20 are spaced apart from each other.

In an embodiment, the clamping unit 30 includes at least one first clamping member 32 and at least one second clamping member 34. The first clamping member 32 and the second clamping member 34 are located on opposite sides of the suction cup units 20 along a third direction Y. The third direction Y is perpendicular to each of the first direction Z and the second direction X. It can be understood that the suction cup units 20 are located between the first clamping member 32 and the second clamping member 34. The first clamping member 32 and the second clamping member 34 are all extend along the second direction X. At least one of the first clamping member 32 and second clamping member 34 can move close to or away from each other to clamp or release the suction cup units 20. For example, the first clamping member 32 can move close to or away from the second clamping member 34, or the second clamping member 34 can move close to or away from the first clamping member 32, or both of the first clamping member 32 and the second clamping member 34 can move close to or away from each other.

Referring to FIGS. 1, 3 and 4, the adsorbing mechanism 100 is used for adsorbing the product 200 with a concave surface. That is, the concave surface is the adsorbing surface 201, and the adsorbing mechanism 100 is used for adsorbing the adsorbing surface 201. The product 200 is placed on a carrying platform 300, and the adsorbing surface 201 faces the adsorbing mechanism 100. The suction cup units 20 divided into two groups, which includes a first group and a second group. In the first direction Z, a projection of the first group of suction cup units 20 coincides with the product 200, while a projection of the second group of suction cup units 20 is located outside the product 200. For example, the number of the suction cup units 20 is nine, but is not limited thereto. The first group includes five suction cup units 20, and the second group includes four suction cup units 20. The number of the suction cup units 20 can be varied according to the size of the product 200 according to an actual situation.

The base 10, the suction cup units 20, and the clamping unit 30 are driven to approach the product 200. The first group of suction cup units 20 is located directly above the product 200 and adsorb the product 200. Since the first group of suction cup units 20 are telescopically mounted on the base 10, the first group of suction cup units 20 can be telescopically adjusted according to the shape of the concave surface 201, thereby ensuring that the first group of suction cup units 20 can fully adsorb the adsorbing surface 201. The second group of suction cup units 20 move to the side of the product 200. The first clamping member 32 and second clamping member 34 of the clamping unit 30 cooperate to clamp the suction cup units 20. The external vacuum device 600 can provide negative pressure to the first group of the suction cup units 20 located directly above the product 200, causing the first group of the suction cup units 20 to adsorb the product 200 under the negative pressure. The second group of suction cup units 20 can clamp the two opposite sides of the product 200 along the second direction X, thereby facilitating the transfer of the product 200.

In an embodiment, the product 200 can be a concave mirror.

It is understandable that the external vacuum device 600 can independently provide negative pressure to one, two, or several suction cup units 20, thereby reducing the air sources and saving costs.

In an embodiment, the suction cup units 20 are arranged in a row, with a gap between adjacent two suction cup units 20. The gap is relatively small, resulting in tight arrangement of multiple suction cup units 20 without interference between them. In this way, the first group of suction cup units 20 can be arranged closely together to adapt to the shape of the adsorbing surface 201, such that the first group of suction cup units 20 can fully adsorb the product 200. At the same time, the second group of suction cup units 20 can also form an effective clamping force on the product 200, thereby further enhancing the adsorption and clamping force on the product 200.

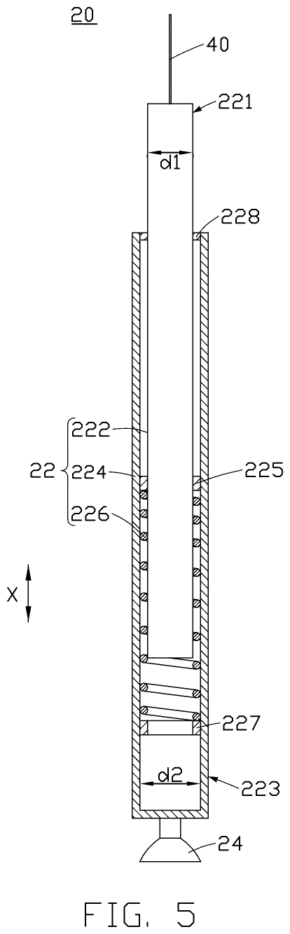

Referring to FIGS. 2 and 5, the suction cup unit 20 includes a telescopic member 22 and a suction cup 24. The telescopic member 22 is telescopically disposed on the base 10. The telescopic member 22 includes a first end 221 and a second end 223 opposite to the first end 221. The first end 221 of the telescopic member 22 is connected to the external vacuum device 600 (see FIG. 1), and the second end 223 of the telescopic member 22 is connected to the suction cup 24. The telescopic member 22 is a hollow structure, and the suction cup 24 is connected to the external vacuum device 600 through the telescopic member 22.

Referring to FIGS. 2 and 5, the telescopic member 22 includes a first cylinder 222, a second cylinder 224, and an elastic component 226. The first cylinder 222 and the second cylinder 224 are substantially hollow structures. A first diameter “d1” of the first cylinder 222 is smaller than a second diameter “d2” of the second cylinder 224. The first cylinder 222 extends through the base 10. One end of the first cylinder 222 away from the second cylinder 224 is the first end 221 and connected to the external vacuum device 600 (see FIG. 1). One end of the second cylinder 224 away from the first cylinder 222 is the second end 222 and connected to the suction cup 24. The second cylinder 224 is slidably sleeved on the first cylinder 222. The second cylinder 224 is in sealed connection with the first cylinder 222. The elastic member 226 is disposed between the first cylinder 222 and the second cylinder 224. The second cylinder 224 is used to move relative to the first cylinder 222 to compress the elastic member 226 to enable the telescopic member 22 to have telescopic function.

The first clamping member 32 and the second clamping member 34 are located on opposite sides of the second cylinder 224. Thereby, the telescopic member 22 can achieve the function of elastic telescoping. When the suction cup 24 abuts against the product 200, the suction cup 24 drives the second cylinder 224 to move upward relative to the first cylinder 222 and compresses the elastic member 226, causing the telescopic member 22 to be shortened. When the first group of suction cup 24 is separated from the product 200, the elastic member 226 rebounds and drives the second cylinder 224 and the suction cup 24 to move downward relative to the first cylinder 222 to return to the original shape.

In an embodiment, the telescopic member 22 further includes a first fixing structure 225 and a second fixing structure 227. The first fixing structure 225 is disposed on an outer surface of the first cylinder 222. The second fixing structure 227 is disposed on an inner surface of the second cylinder 224. Two end of the elastic member 226 are respectively fixed on the first fixing structure 225 and the second fixing structure 227, so that the elastic member 226 can be disposed between the first cylinder 222 and the second cylinder 224.

In an embodiment, the elastic member 226 may be a spring.

In an embodiment, a sealing ring 228 is arranged between the second cylinder 224 and the first cylinder 222, so that the second cylinder 224 and the first cylinder 222 are connected in a sealed manner.

In an embodiment, an adaptive structure (not shown) such as a protrusion (not shown) and groove (not shown) can also be provided between the first cylinder 222 and the second cylinder 224 to prevent separation of the first cylinder 222 from the second cylinder 224.

In an embodiment, the suction cup 24 may be made of soft material, thus the suction cup 24 can more closely adhere to the product 200. In an embodiment, a material of the suction cup 24 may be silicone.

Referring to FIG. 2, the adsorbing mechanism 100 further includes a plurality

of hoses 40, which are connected to the suction cup units 20 one-by-one. The hose 40 is connects the external vacuum device 600 to the first end 221 of the telescopic member 22. When the base 10, the suction cup units 20, and the clamping unit 30 move approach or away from the product 200, the hose 40 can provide a certain space for the base 10, the suction cup units 20, and the clamping unit 30 to move, thereby ensuring that the suction cup units 20 are in communication with the external vacuum device 600 and improving the stability of vacuum adsorption.

The first clamping member 32 is fixed on one side of the suction cup units 20 and is spaced apart from the suction cup units 20. There is a small gap between the first clamping member 32 and the suction cup units 20. That is, the first clamping member 32 does not interfere with the second cylinder 224 during the second cylinder 224 move along the first direction Z. The second clamping member 34 is movably disposed on a side of the suction cup units 20 away from the first clamping member 32. The second clamping member 34 can move close to or away from the first clamping member 32. When the first group of suction cup units 20 adsorbs the product 200, the second clamping member 34 can move close to the first clamping member 32 to clamp the suction cup units 20. Thus, by limiting the first clamping member 32 to be fixedly arranged and the second clamping member 34 to be movably arranged, the power source is reduced, and the cost is saved.

In an embodiment, the clamping unit 30 includes one first clamping member

32 and two second clamping members 34. The two second clamping members 34 are parallel to each other. The two clamping members 34 are arranged at intervals along the first direction Z. Along the third direction Y, a projection of the first clamping member 32 is between projections of the two second clamping members 34. That is, the first clamping member 32 and the two second clamping members 34 are arranged at intervals along the first direction Z. Thus, when the second clamping members 34 cooperate with the first clamping members 32 to clamp the suction cup units 20, the two second clamping members 34 can abut against the suction cup units 20 with a larger area. Thereby, the clamping stability of the suction cup units 20 is improved, and the suction cup units 20 will not deflect.

In another embodiment, the clamping unit 30 can also include two or more than two first clamping member 32, and more than two second clamping member 34. For example, the number of the first clamping member 32 is two, and the number of the second clamping member 34 is three. The two first clamping members 32 and the three second clamping members 34 are arranged in a staggered manner along the first direction X. For another example, the number of the first clamping member 32 is three, and the number of the second clamping member 34 is four. The three first clamping members 32 and the four second clamping members 34 are arranged in a staggered manner along the first direction Z. The specific number of the first clamping members 32 and the second clamping members 34 can be set according to the actual situation.

The clamping unit 30 further includes a driving member 36. In an embodiment, the driving member 36 may be a linear cylinder. The driving member 36 is connected to the second clamping member 34. The driving member 36 is used to drive the second clamping member 34 to move close to or away from the first clamping member 32.

Thereby, the driving member 36 is provided to achieve the function of driving the second clamping member 34 to move.

In another embodiment, when the first clamping member 32 is movably arranged and the second clamping member 34 is fixedly arranged, the driving member 36 can be connected to the first clamping member 32.

In yet another embodiment, when both the first clamping member 32 and the second clamping member 34 are movably arranged, the driving member 36 can be connected to the first clamping member 32 and the second clamping member 34, respectively. For example, the driving member 36 may be a double-headed linear cylinder. The driving member 36 can drive the first clamping member 32 and the second clamping member 34 to approach or move away from each other.

Referring to FIG. 1, the adsorbing device 1000 further includes a connection base 500. The connection base 500 is connected to the base 10 and the clamping unit 30 of the adsorbing mechanism 100, as well as to the moving mechanism 400. The moving mechanism 400 drives the adsorbing mechanism 100 to move through the connection base 500. In an embodiment, the base 10 can be connected to the connection base 500, the first clamping member 32 of the clamping unit 30 can be connected to the connection base 500, the driving member 36 of the clamping unit 30 can be connected to the connection base 500.

In an embodiment, the moving mechanism 400 may be a robot arm or a multi-axis linear module.

When the adsorbing mechanism 100 and adsorbing device 1000 are used for transferring product 200 with an irregular adsorbing surface 201, the base 10, the suction cup units 20, and the clamping unit 30 are driven to move to the product 200. The first group of suction cup units 20 is located directly above the product 200 and can abut against the adsorbing surface 201. Then, the first group of suction cup units 20 can telescopically move according to the adsorbing surface 201 of the product 200, thereby ensuring that the first group of suction cup units 20 can adsorb the adsorbing surface 201. When the second group of suction cup units 20 moves to the sides of the product 200, the base 10, the suction cup units 20, and the clamping unit 30 stop moving. The second group of suction cup units 20 forms a clamping force on the sides of the product 200. When the base 10, the multiple suction cup units 20, and the clamping unit 30 stop moving, the first clamping member 32 and the second clamping members 34 of the clamping unit 30 clamp the suction cup units 20, allowing the suction cup units 20 to maintain adsorption and clamping forces on the product 200 for easy transfer.

With the above configuration, the adsorbing mechanism 100 can attach to and adsorb the product 200 through the cooperation of the multiple suction cup units 20 and the clamping unit 30, and the suction cup units 20 can also form a clamping force on the product 200. Thereby, the adsorbing mechanism 100 can stably adsorb the product 200, thereby preventing damages to the product 200 due to the product 200 being separating from the adsorbing mechanism 100, and the waste of the product 200 may be reduced. In addition, since the suction cup unit 20 can telescopically move, the adsorbing mechanism 100 can be applied to products 200 with different adsorbing surfaces and materials. The adsorbing mechanism 100 has a wide range of applicability and can meet the production needs of a small number of diverse products 200. The adsorbing mechanism 100 has a simple structure and low cost.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An adsorbing mechanism comprising:
a base;
a plurality of suction cup units disposed on the base and parallel to each other, each of the plurality of suction cup units configured to telescopically move along a first direction, and the plurality of suction cup units further configured for connecting to an external vacuum device, such that a negative pressure is generated in the plurality of suction cup units for adsorbing an adsorbing surface of a product; and
a clamping unit disposed on a side of the base along the first direction, the clamping unit comprising a first clamping member and a second clamping member, wherein the first clamping member and the second clamping member are located on opposite sides of the plurality of suction cup units, respectively, along a third direction, the third direction is perpendicular to the first direction,
wherein at least one of the first clamping member and the second clamping member is configured to move close to or away from each other to clamp or release the plurality of suction cup units.

2. The adsorbing mechanism according to claim 1, wherein each of the plurality of suction cup units comprises a telescopic member and a suction cup, the telescopic member is telescopically disposed on the base, the telescopic member comprises a first end and a second end opposites to the first end, the first end is configured for connecting to the external vacuum device, the second end is connected to the suction cup, the telescopic member is a hollow structure, and the suction cup is connected to the external vacuum device through the telescopic member.

3. The adsorbing mechanism according to claim 2, wherein the telescopic member further comprises a first cylinder, a second cylinder, and an elastic component, the first cylinder extends through the base, one end of the first cylinder away from the second cylinder is the first end and connected to the external vacuum device, one end of the second cylinder away from the first cylinder is the second end and connected to the suction cup, the second cylinder is slidably sleeved on the first cylinder, the elastic member is disposed between the first cylinder and the second cylinder, the second cylinder is configured to move relative to the first cylinder to compress the elastic member, and the first clamping member and the second clamping member are located on opposite sides of the second cylinder along the third direction.

4. The adsorbing mechanism according to claim 3, wherein the telescopic member further comprises a first fixing structure and a second fixing structure, the first fixing structure is disposed on an outer surface of the first cylinder, the second fixing structure is disposed on an inner surface of the second cylinder, and two end of the elastic member are fixed on the first fixing structure and the second fixing structure, respectively.

5. The adsorbing mechanism according to claim 3, wherein the telescopic member further comprises a sealing ring disposed between the second cylinder and the first cylinder.

6. The adsorbing mechanism according to claim 1, wherein the first clamping member is fixed on one side of the plurality of suction cup units and spaced apart from the plurality of suction cup units, the second clamping member is movably disposed on a side of the plurality of suction cup units away from the first clamping member, and the second clamping member is configured to move close to or away from the first clamping member.

7. The adsorbing mechanism according to claim 6, wherein the clamping unit further comprises a driving member, the driving member is connected to the second clamping member, and the driving member is configured to drive the second clamping member to move close to or away from the first clamping member.

8. The adsorbing mechanism according to claim 1, wherein the plurality of suction cup units is arranged in a row along a second direction, and the second direction is perpendicular to each of the first direction and the second direction.

9. The adsorbing mechanism according to claim 1, wherein the clamping unit comprises one first clamping member and two second clamping member, the two second clamping members are parallel to each other, the two clamping members are spaced from each other along the first direction, along the third direction, an projection of the first clamping member is between projections of the two second clamping members.

10. An adsorbing device comprising:
an adsorbing mechanism comprising:
a base;
a plurality of suction cup units disposed on the base and parallel to each other, each of the plurality of suction cup units configured to telescopically move along a first direction, and the plurality of suction cup units further configured for connecting connected to an external vacuum device, such that a negative pressure is generated in the plurality of suction cup units for adsorbing an adsorbing surface of a product; and
a clamping unit disposed on a side of the base along the first direction, the clamping unit comprising a first clamping member and a second clamping member, wherein the first clamping member and the second clamping member are located on opposite sides of the plurality of suction cup units, respectively, along a third direction, the third direction is perpendicular to the first direction,
wherein at least one of the first clamping member and the second clamping member is configured to move close to or away from each other to clamp or release the plurality of suction cup units; and
a transferring mechanism configured to drive the adsorbing mechanism to move.

11. The adsorbing device according to claim 10, wherein each of the plurality of suction cup units comprises a telescopic member and a suction cup, the telescopic member is telescopically disposed on the base, the telescopic member comprises a first end and a second end opposites to the first end, the first end is configured for connecting to the external vacuum device, the second end is connected to the suction cup, the telescopic member is a hollow structure, and the suction cup is connected to the external vacuum device through the telescopic member.

12. The adsorbing device according to claim 11, wherein the telescopic member further comprises a first cylinder, a second cylinder, and an elastic component, the first cylinder is extends through the base, one end of the first cylinder away from the second cylinder is the first end and connected to the external vacuum device, one end of the second cylinder away from the first cylinder is the second end and connected to the suction cup, the second cylinder is slidably sleeved on the first cylinder, the elastic member is disposed between the first cylinder and the second cylinder, the second cylinder is configured to move relative to the first cylinder to compress the elastic member, and the first clamping member and the second clamping member are located on opposite sides of the second cylinder along the third direction.

13. The adsorbing device according to claim 12, wherein the telescopic member further comprises a first fixing structure and a second fixing structure, the first fixing structure is disposed on an outer surface of the first cylinder, the second fixing structure is disposed on an inner surface of the second cylinder, and two end of the elastic member are fixed on the first fixing structure and the second fixing structure, respectively.

14. The adsorbing device according to claim 12, wherein the telescopic member further comprises a sealing ring disposed between the second cylinder and the first cylinder.

15. The adsorbing device according to claim 10, wherein the first clamping member is fixed on one side of the plurality of suction cup units and spaced apart from the plurality of suction cup units, the second clamping member is movably disposed on a side of the plurality of suction cup units away from the first clamping member, and the second clamping member is configured to move close to or away from the first clamping member.

16. The adsorbing device according to claim 15, wherein the clamping unit further comprises a driving member, the driving member is connected to the second clamping member, and the driving member is configured to drive the second clamping member to move close to or away from the first clamping member.

17. The adsorbing device according to claim 10, wherein the plurality of suction cup units are arranged in a row along a second direction, the second direction is perpendicular to each of the first direction and the second direction.

18. The adsorbing device according to claim 10, wherein the clamping unit comprises one first clamping member and two second clamping member, the two second clamping members are parallel to each other, the two clamping members are spaced from each other along the first direction, along the third direction, an projection of the first clamping member is between projections of the two second clamping members.

19. The adsorbing device according to claim 10, further comprising a connection base, wherein the connection base is connected to the base, the clamping unit, and the moving mechanism, the moving mechanism drives the adsorbing mechanism to move through the connection base.

20. The adsorbing device according to claim 10, wherein the moving mechanism is a robot arm or a multi-axis linear module.
